(19) United States
(12) Patent Application Publication
(10) Pub. No.: US 2026/0230249 A1
(43) Pub. Date: Aug. 6, 2026

(54) SUB-RESOURCE UNIT BASED ADAPTIVE MODULATION SCHEMES IN WIRELESS COMMUNICATIONS

(71) Applicant: MEDIATEK INC., Hsinchu City (TW)

(72) Inventors: Jianhan LIU, San Jose, CA (US); Shengquan HU, San Jose, CA (US); Thomas Edward PARE, JR., San Jose, CA (US)

(21) Appl. No.: 19/151,681

(22) PCT Filed: Feb. 1, 2025
(86) PCT No.: PCT/CN2024/075228

§ 371 Date: Jul. 29, 2025

Related U.S. Application Data
(60) Provisional application No. 63/482,818, filed on Feb. 2, 2023.

(51) Int. Cl. H04L 5/00; H04L 27/36

(52) U.S. Cl. CPC H04L 5/0044; H04L 27/36

(57) ABSTRACT

Techniques pertaining to sub-resource unit (sub-RU) based adaptive modulation schemes in wireless communications are described. An apparatus (e.g., a station (STA)) generates a resource unit (RU) or multi-RU (MRU) of a physical-layer protocol data unit (PPDU), the RU or MRU being composed of multiple sub-RUs each having a smaller size than that of the RU or MRU. The apparatus then transmits the PPDU with sub-RU based adaptive modulation.

### CROSS REFERENCE TO RELATED PATENT APPLICATION

The present disclosure is part of a non-provisional patent application claiming the priority benefit of U.S. Provisional Patent Application No. 63/482,818, filed 2 Feb. 2023, the content of which herein being incorporated by reference in its entirety.

### TECHNICAL FIELD

The present disclosure is generally related to wireless communications and, more particularly, to sub-resource unit (sub-RU) based adaptive modulation schemes in wireless communications.

### BACKGROUND

Unless otherwise indicated herein, approaches described in this section are not prior art to the claims listed below and are not admitted as prior art by inclusion in this section.

In wireless communications, such as wireless local area networks (WLANs) based on one or more Institute of Electrical and Electronics Engineers (IEEE) 802.11 standards, most channels are usually semi-static frequency selective channels. Per-subcarrier bit-loading may be applied to enhance the spectral efficiency. That is, per-subcarrier bit-loading is used to modulate different numbers of bits on each subcarrier based on the signal-to-noise ratio (SNR) of the subcarrier. Since each subcarrier has its own modulation, bit-loading information signaling overhead is significant in a physical-layer protocol data unit (PPDU) and, therefore, per-subcarrier adaptive bit-loading is not very practical in WLAN. Per-subcarrier bit-loading also requires each subcarrier's real-time channel state information or SNR, the feedback overhead is also high. Therefore, there is a need for a solution of sub-RU based adaptive modulation schemes for future WLANs so as to better utilize the semi-static frequency selective channels and avoid significant overhead.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to sub-RU based adaptive modulation schemes in wireless communications. It is believed that the aforementioned issue(s) may be avoided or otherwise alleviated by implementation of one or more of the various proposed schemes described herein.

In one aspect, a method may involve generating a RU or MRU of a PPDU, with the RU or MRU being composed of multiple sub-RUs each having a smaller size than that of the RU or MRU. The method may also involve transmitting the PPDU with sub-RU based adaptive modulation.

In another aspect, an apparatus may include a transceiver configured to communicate wirelessly and a processor coupled to the transceiver. The processor may generate a RU or MRU of a PPDU, with the RU or MRU being composed of multiple sub-RUs each having a smaller size than that of the RU or MRU. The processor may also transmit the PPDU with sub-RU based adaptive modulation.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example structure under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a block diagram of an example communication system in accordance with an implementation of the present disclosure.

FIG. 7 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to sub-RU based adaptive modulation schemes in wireless communications. According to the present disclosure, a number of possible solutions may be implemented separately or jointly. That is, although these possible solutions may be described below separately, two or more of these possible solutions may be implemented in one combination or another.

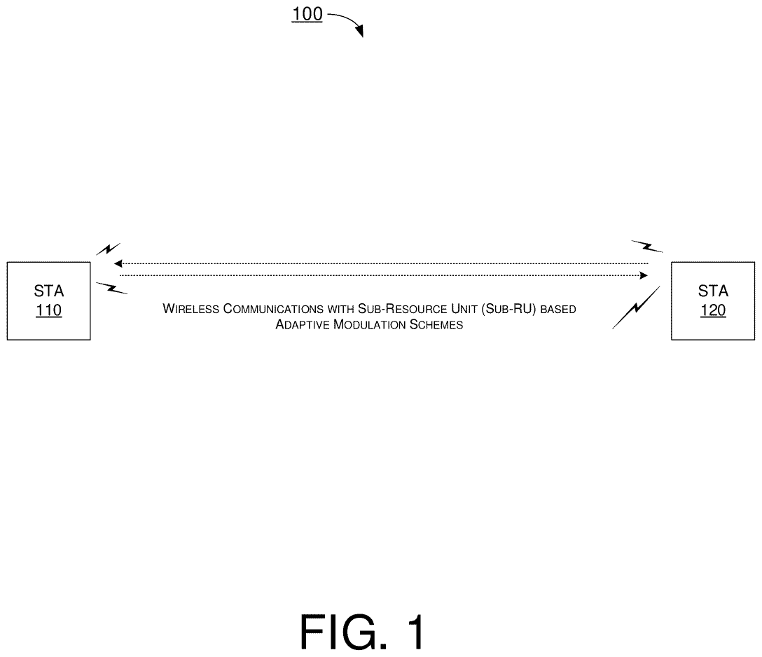

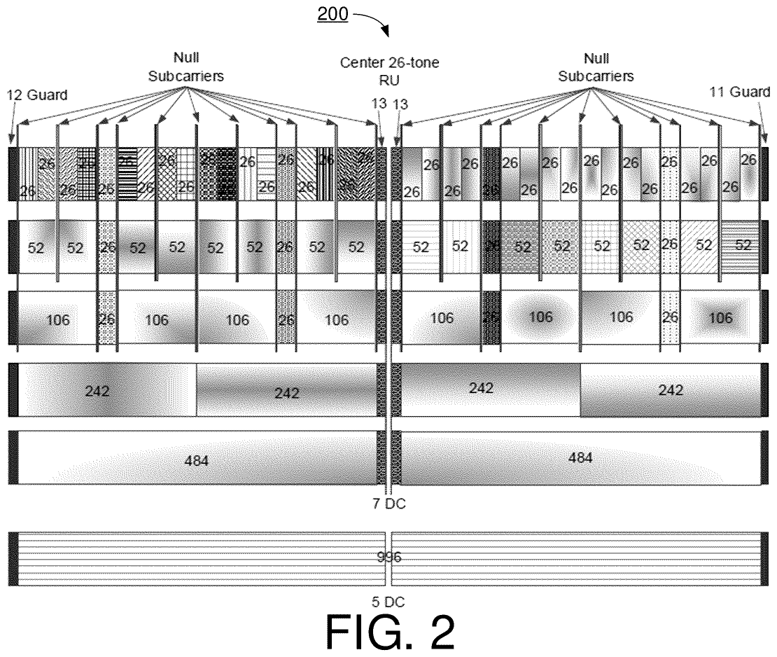

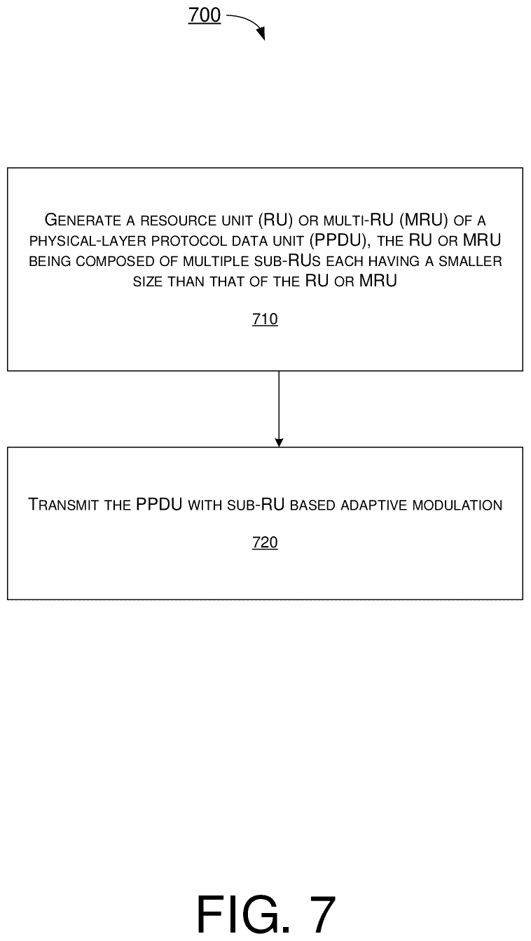

FIG. 1 illustrates an example network environment 100 in which various solutions and schemes in accordance with the present disclosure may be implemented. FIG. 2~FIG. 7 illustrate examples of implementation of various proposed schemes in network environment 100 in accordance with the present disclosure. The following description of various proposed schemes is provided with reference to FIG. 1~FIG. 7.

Referring to FIG. 1, network environment 100 may involve at least a STA 110 communicating wirelessly with a STA 120. Each of STA 110 and STA 120 may be an access point (AP) STA or a non-access point (non-AP) STA. In some cases, STA 110 and STA 120 may be associated with a basic service set (BSS) in accordance with one or more IEEE 802.11 standards (e.g., IEEE 802.11be and future-developed standards). Each of STA 110 and STA 120 may be configured to communicate with each other by utilizing the techniques pertaining to sub-RU based adaptive modulation schemes in wireless communications in accordance with various proposed schemes described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In WLAN systems based on the IEEE 802.11ax, IEEE 802.11be and future generations, RUs and aggregation of multiple RUs (herein referred to as multi-RU or MRU) are introduced to enable orthogonal frequency-division multiple-access (OFDMA) transmissions. FIG. 2 illustrates an example structure 200 of RUs within an 80 MHz frequency subblock in WLAN communications. Referring to FIG. 2, an 80 MHz frequency subblock may contain one 996-tone RU, two 484-tone RUs, four 242-tone RUs, eight 106-tone RUs, sixteen 52-tone RUs or thirty-seven 36-tone RUs. Moreover, each larger-size RU may be composed of several smaller-size RUs (e.g., one 996-tone RU may be composed of two 484-tone RUs or four 242-tone RUs). Accordingly, in the present disclosure, the smaller-size RUs within a larger-size RU may be referred to as “sub-RUs” of the larger-size RUs.

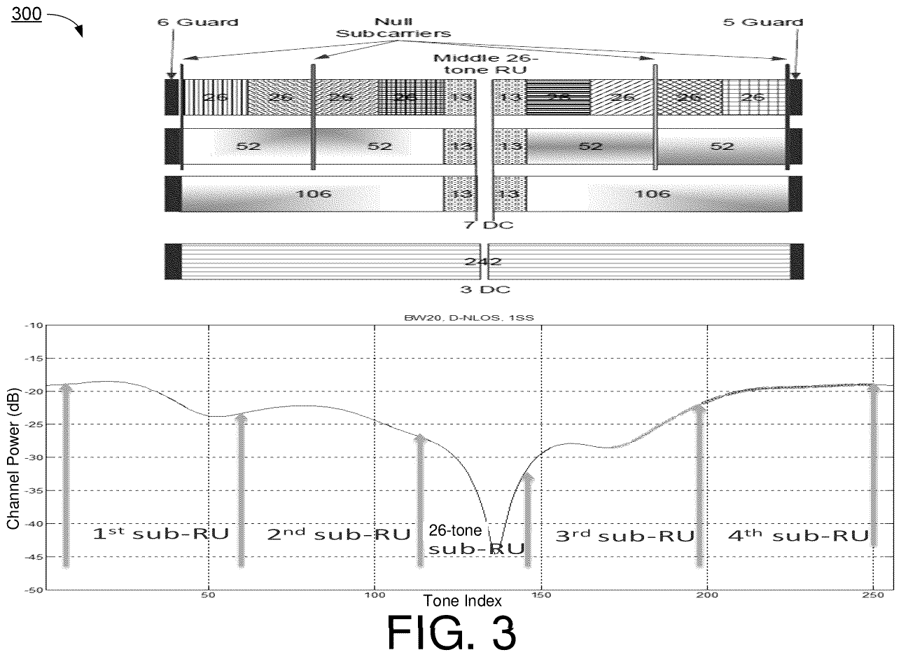

FIG. 3 illustrates an example scenario 300 under a proposed scheme of sub-RU based adaptive modulations in accordance with the present disclosure. Under the proposed scheme, different sub-RUs may be assigned different modulations based on the overall SNR and/or signal-to-interference-and-noise ratio (SINR) of all subcarriers in each sub-RU. Referring to the example shown in FIG. 3, a STA (e.g., STA 110 or STA 120) may be assigned with a 242-tone RU and, within the 242-tone RU, each sub-RU may have its own modulation. For instance, among the four 52-tone sub-RUs and one 26-tone sub-RU of which the 242-tone RU is composed, the 26-tone sub-RU may be assigned with a lowest modulation scheme while the first 52-tone sub-RU and the fourth 52-tone sub-RU may be assigned with the highest modulation scheme. Under the proposed scheme, all subcarriers within a given sub-RU may be modulated by the same modulation scheme.

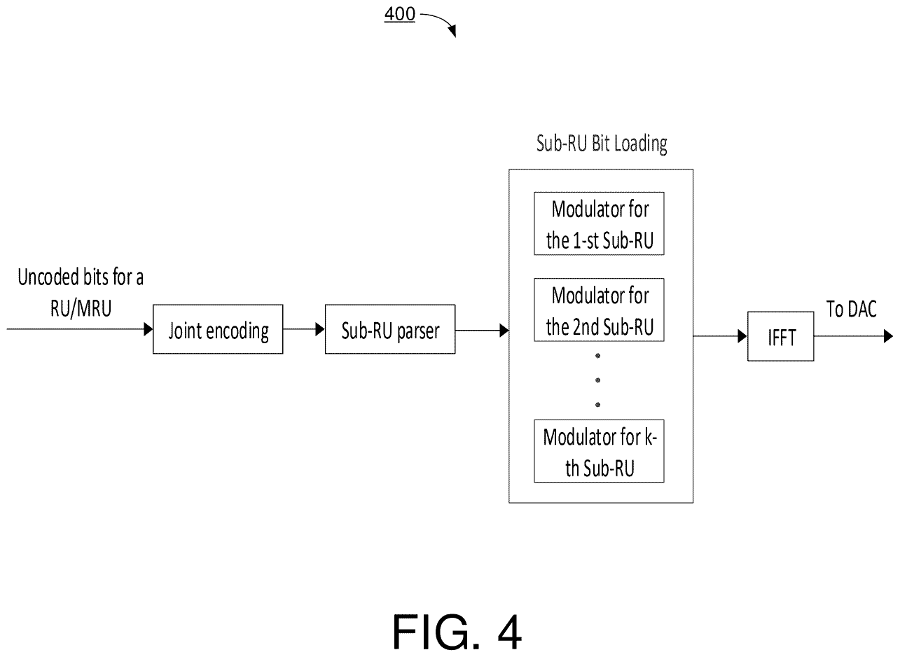

FIG. 4 illustrates an example scenario 400 under a proposed scheme of sub-RU based adaptive modulations in accordance with the present disclosure. Under the proposed scheme, sub-RU based adaptive modulations may be applied on an MRU as well. For example, in case that a STA (e.g., STA 110 or STA 120) is assigned with a non-contiguous 484+996-tone MRU (that is, an aggregation of a 484-tone RU and a 996-tone RU as one MRU), the sub-RUs in the 484-tone RU and the 996-tone RU may use adaptive modulations. For each RU or MRU defined in the IEEE 802.11 standard family, sub-RUs for adaptive modulations may be a subset of existing sub-RUs. For instance, a 242-tone RU may be composed of two 106-tone sub-RUs, and each of the two 106-tone sub-RUs may respectively be composed of two 52-tone sub-RUs. Under the proposed scheme, two different modulation schemes may be assigned to the two 52-tone sub-RUs of either or both of the two 106-tone sub-RUs of the 242-tone RU.

Scenario 400 shows an example of sub-RU bit-loading with each sub-RU modulated according to its assigned modulation scheme. Referring to FIG. 4, a stream of uncoded bits for a given RU or MRU may be jointly encoded. That is, the information bits of all sub-RUs within the RU or MRU may be encoded together. Then, a sub-RU parser may parse the sub-RUs for sub-RU bit-loading. Each sub-RU may be modulated according to its assigned modulation scheme. Afterwards, an inverse fast Fourier transform (IFFT) may be applied before the encoded bits are sent to a digital-to-analog converter (DAC) for transmission.

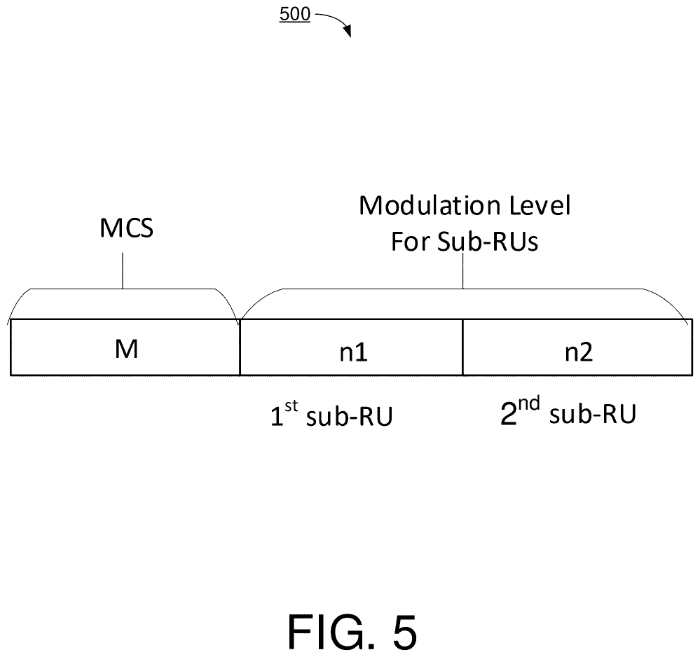

FIG. 5 illustrates an example scenario 500 under a proposed scheme of signaling of sub-RU modulations information in accordance with the present disclosure. Under the proposed scheme, sub-RU modulation information may be carried in the User Specific field in the physical-layer (PHY) header of a PPDU. Under the proposed scheme, each STA's user field may contain information of modulations of predefined sub-RUs contained in the assigned RU or MRU. For instance, for a 2×996-tone MRU, its predefined sub-RUs may be two 996-tone RUs. There may be two quadrature amplitude modulation (QAM) indications, namely: one for the first 996-tone RU and the other for the second 996-tone RU.

Under the proposed scheme, the sub-RU modulation information may be compressed using a differential method. More specifically, a modulation and coding scheme (MCS) with a highest modulation (QAM-level) of the sub-RUs may be indicated explicitly (e.g. by setting modulation level to 0), while the modulation of each of remaining sub-RUs may be indicated by a difference between its respective modulation and the highest modulation. For instance, referring to FIG. 5, in an event that n1 is 0, meaning the first sub-RU uses the modulation indicated in MCS field, then n2 may indicate that the second sub-RU uses the modulation that is n2 levels down from the modulation of the first sub-RU.

Under a proposed scheme in accordance with the present disclosure, joint encoding of multiple sub-RUs may be performed with extra modulations. To reduce the complexity, under the proposed scheme, all sub-RUs may be jointly encoded (e.g., with information bits of all the sub-RUs encoded together) such that only the modulations on the subcarriers in different sub-RUs may be different. Since it is possible that the required SNR between two consecutive modulations may be quite large, the gain of sub-RU based adaptive modulation may be diminished. To enhance the gain of sub-RU based adaptive modulation, under the proposed scheme, extra modulation may be introduced. For instance, modulations for 3 bits, 5 bits and 7 bits may be introduced.

### Illustrative Implementations

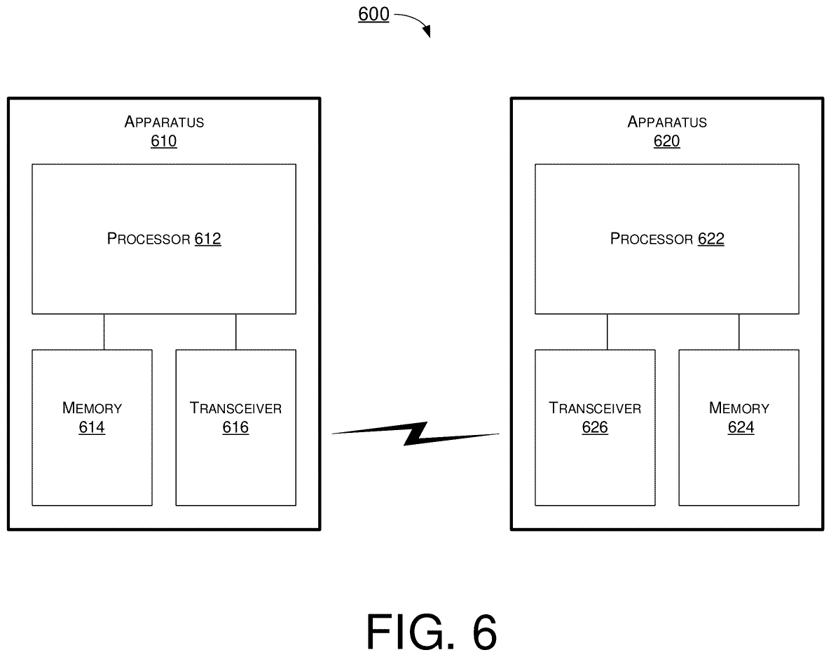

FIG. 6 illustrates an example system 600 having at least an example apparatus 610 and an example apparatus 620 in accordance with an implementation of the present disclosure. Each of apparatus 610 and apparatus 620 may perform various functions to implement schemes, techniques, processes and methods described herein pertaining to sub-RU based adaptive modulation schemes in wireless communications, including the various schemes described above with respect to various proposed designs, concepts, schemes, systems and methods described above as well as processes described below. For instance, apparatus 610 may be implemented in STA 110 and apparatus 620 may be implemented in STA 120, or vice versa.

Each of apparatus 610 and apparatus 620 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 610 and apparatus 620 may be implemented in a smartphone, a smart watch, a personal digital assistant, a digital camera, or a computing equipment such as a tablet computer, a laptop computer or a notebook computer. Each of apparatus 610 and apparatus 620 may also be a part of a machine type apparatus, which may be an IoT apparatus such as an immobile or a stationary apparatus, a home apparatus, a wire communication apparatus or a computing apparatus. For instance, each of apparatus 610 and apparatus 620 may be implemented in a smart thermostat, a smart fridge, a smart door lock, a wireless speaker or a home control center. When implemented in or as a network apparatus, apparatus 610 and/or apparatus 620 may be implemented in a network node, such as an AP in a WLAN.

In some implementations, each of apparatus 610 and apparatus 620 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 610 and apparatus 620 may be implemented in or as a STA or an AP. Each of apparatus 610 and apparatus 620 may include at least some of those components shown in FIG. 6 such as a processor 612 and a processor 622, respectively, for example. Each of apparatus 610 and apparatus 620 may further include one or more other components not pertinent to the proposed scheme of the present disclosure (e.g., internal power supply, display device and/or user interface device), and, thus, such component(s) of apparatus 610 and apparatus 620 are neither shown in FIG. 6 nor described below in the interest of simplicity and brevity.

In one aspect, each of processor 612 and processor 622 may be implemented in the form of one or more single-core processors, one or more multi-core processors, one or more RISC processors or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including those pertaining to sub-RU based adaptive modulation schemes in wireless communications in accordance with various implementations of the present disclosure.

In some implementations, apparatus 610 may also include a transceiver 616 coupled to processor 612. Transceiver 616 may include a transmitter capable of wirelessly transmitting and a receiver capable of wirelessly receiving data. In some implementations, apparatus 620 may also include a transceiver 626 coupled to processor 622. Transceiver 626 may include a transmitter capable of wirelessly transmitting and a receiver capable of wirelessly receiving data. It is noteworthy that, although transceiver 616 and transceiver 626 are illustrated as being external to and separate from processor 612 and processor 622, respectively, in some implementations, transceiver 616 may be an integral part of processor 612 as a system on chip (SoC), and transceiver 626 may be an integral part of processor 622 as a SoC.

In some implementations, apparatus 610 may further include a memory 614 coupled to processor 612 and capable of being accessed by processor 612 and storing data therein. In some implementations, apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

Each of apparatus 610 and apparatus 620 may be a communication entity capable of communicating with each other using various proposed schemes in accordance with the present disclosure. For illustrative purposes and without limitation, a description of capabilities of apparatus 610, as STA 110, and apparatus 620, as STA 120, is provided below in the context of example process 700. It is noteworthy that, although a detailed description of capabilities, functionalities and/or technical features of apparatus 620 is provided below, the same may be applied to apparatus 610 although a detailed description thereof is not provided solely in the interest of brevity. It is also noteworthy that, although the example implementations described below are provided in the context of WLAN, the same may be implemented in other types of networks.

### Illustrative Processes

FIG. 7 illustrates an example process 700 in accordance with an implementation of the present disclosure. Process 700 may represent an aspect of implementing various proposed designs, concepts, schemes, systems and methods described above. More specifically, process 700 may represent an aspect of the proposed concepts and schemes pertaining to sub-RU based adaptive modulation schemes in wireless communications in accordance with the present disclosure. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed repeatedly or iteratively. Process 700 may be implemented by or in apparatus 610 and apparatus 620 as well as any variations thereof. Solely for illustrative purposes and without limiting the scope, process 700 is described below in the context of apparatus 610 implemented in or as STA 110 functioning as a non-AP STA and apparatus 620 implemented in or as STA 120 functioning as an AP STA of a wireless network such as a WLAN in network environment 70 in accordance with one or more of IEEE 802.11 standards. Process 700 may begin at block 710.

At 710, process 700 may involve processor 612 of apparatus 610 generating a RU or MRU (e.g., an aggregate of multiple RUs) of a PPDU. The RU or MRU may be composed of multiple sub-RUs each having a smaller size than that of the RU or MRU. Process 700 may proceed from 710 to 720.

At 720, process 700 may involve processor 612 transmitting, via transceiver 616, the PPDU with sub-RU based adaptive modulation.

In some implementations, in generating the RU or MRU composed of the multiple sub-RUs, process 700 may involve processor 612 assigning each of the multiple sub-RUs with a respective modulation.

In some implementations, in assigning each of the multiple sub-RUs with the respective modulation, process 700 may involve processor 612 assigning each of the multiple sub-RUs with the respective modulation based on an overall SNR or SINR of all subcarriers in each sub-RU.

In some implementations, a first modulation assigned to a first sub-RU of the multiple sub-RUs and a second modulation assigned to a second sub-RU of the multiple sub-RUs may be different.

In some implementations, all subcarriers within each sub-RU may be modulated by the respective modulation.

In some implementations, information of the sub-RU based adaptive modulation may be carried in a User Specific field in a PHY header of the PPDU.

In some implementations, the information of the sub-RU based adaptive modulation may include a QAM-level indication for each sub-RU of the multiple sub-RUs.

In some implementations, the information of the sub-RU based adaptive modulation may be compressed using a differential method. For instance, the differential method may involve indicating a highest modulation of the sub-RUs and, for each sub-RU of the multiple sub-RUs, indicating a difference between a respective modulation and the highest modulation.

In some implementations, a size of one or more of the multiple sub-RUs may be 3 bits, 5 bits or 7 bits.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating a resource unit (RU) or multi-RU (MRU) of a physical-layer protocol data unit (PPDU), the RU or MRU being composed of multiple sub-RUs each having a smaller size than that of the RU or MRU; and
transmitting the PPDU with sub-RU based adaptive modulation.

2. The method of claim 1, wherein the generating of the RU or MRU composed of the multiple sub-RUs comprises assigning each of the multiple sub-RUs with a respective modulation.

3. The method of claim 2, wherein the assigning of each of the multiple sub-RUs with the respective modulation comprises assigning each of the multiple sub-RUs with the respective modulation based on an overall signal-to-noise ratio (SNR) or signal-to-interference-and-noise ratio (SINR) of all subcarriers in each sub-RU.

4. The method of claim 2, wherein a first modulation assigned to a first sub-RU of the multiple sub-RUs and a second modulation assigned to a second sub-RU of the multiple sub-RUs are different.

5. The method of claim 2, wherein all subcarriers within each sub-RU are modulated by the respective modulation.

6. The method of claim 1, wherein information of the sub-RU based adaptive modulation is carried in a User Specific field in a physical-layer (PHY) header of the PPDU.

7. The method of claim 6, wherein the information of the sub-RU based adaptive modulation comprises a quadrature amplitude modulation (QAM)-level indication for each sub-RU of the multiple sub-RUs.

8. The method of claim 6, wherein the information of the sub-RU based adaptive modulation is compressed using a differential method.

9. The method of claim 8, wherein the differential method involves indicating a highest modulation of the sub-RUs and, for each sub-RU of the multiple sub-RUs, indicating a difference between a respective modulation and the highest modulation.

10. The method of claim 1, wherein a size of one or more of the multiple sub-RUs is 3 bits, 5 bits or 7 bits.

11. An apparatus, comprising:
a transceiver configured to communicate wirelessly; and
a processor coupled to the transceiver and configured to perform, via the transceiver, operations comprising:
generating a resource unit (RU) or multi-RU (MRU) of a physical-layer protocol data unit (PPDU), the RU or MRU being composed of multiple sub-RUs each having a smaller size than that of the RU or MRU; and
transmitting the PPDU with sub-RU based adaptive modulation.

12. The apparatus of claim 11, wherein the generating of the RU or MRU composed of the multiple sub-RUs comprises assigning each of the multiple sub-RUs with a respective modulation.

13. The apparatus of claim 12, wherein the assigning of each of the multiple sub-RUs with the respective modulation comprises assigning each of the multiple sub-RUs with the respective modulation based on an overall signal-to-noise ratio (SNR) or signal-to-interference-and-noise ratio (SINR) of all subcarriers in each sub-RU.

14. The apparatus of claim 12, wherein a first modulation assigned to a first sub-RU of the multiple sub-RUs and a second modulation assigned to a second sub-RU of the multiple sub-RUs are different.

15. The apparatus of claim 12, wherein all subcarriers within each sub-RU are modulated by the respective modulation.

16. The apparatus of claim 11, wherein information of the sub-RU based adaptive modulation is carried in a User Specific field in a physical-layer (PHY) header of the PPDU.

17. The apparatus of claim 16, wherein the information of the sub-RU based adaptive modulation comprises a quadrature amplitude modulation (QAM)-level indication for each sub-RU of the multiple sub-RUs.

18. The apparatus of claim 16, wherein the information of the sub-RU based adaptive modulation is compressed using a differential method.

19. The apparatus of claim 18, wherein the differential method involves indicating a highest modulation of the sub-RUs and, for each sub-RU of the multiple sub-RUs, indicating a difference between a respective modulation and the highest modulation.

20. The apparatus of claim 11, wherein a size of one or more of the multiple sub-RUs is 3 bits, 5 bits or 7 bits.
